(19) United States
(12) Patent Application Publication
(10) Pub. No.: US 2026/0153049 A1
(43) Pub. Date: Jun. 4, 2026

(54) INTERCOOLER AND AN ENGINE SYSTEM INCLUDING THE SAME

(71) Applicants: HYUNDAI MOTOR COMPANY, Seoul (KR); KIA CORPORATION, Seoul (KR)

(72) Inventors: Sung Il Yoon, Hwaseong-si (KR); Hee Yong Choi, Hwaseong-si (KR); Jeong Eui Kong, Hwaseong-si (KR)

(73) Assignees: HYUNDAI MOTOR COMPANY, Seoul (KR); KIA CORPORATION, Seoul (KR)

(21) Appl. No.: 19/196,358

(22) Filed: May 1, 2025

(30) Foreign Application Priority Data
Nov. 29, 2024 (KR) 10-2024-0174513

(51) Int. Cl. F02B 29/04; F02M 26/04; F02M 26/31

(52) U.S. Cl. CPC F02B 29/0456; F02M 26/04; F02M 26/31

(57) ABSTRACT

An intercooler includes: a plurality of tubes configured to allow introduced intake gas to flow therein and flow out and arranged in a height direction of the intercooler; and a cooling fin structure forming a cooling passage within the plurality of tubes. In particular, the cooling fin structure is disposed to be offset to one widthwise side within the plurality of tubes so as to form a cooling efficiency reduction passage on the other widthwise side within the plurality of tubes.

### CROSS-REFERENCE TO RELATED APPLICATION(S)

This application claims benefit of and priority to Korean Patent Application No. 10-2024-0174513, filed on Nov. 29, 2024 in the Korean Intellectual Property Office, the disclosure of which is incorporated herein by reference in its entirety.

### BACKGROUND

### 1. Field

The present disclosure relates to an intercooler and an engine system including the same.

### 2. Description of Related Art

Generally, an engine system of a vehicle may be equipped with an exhaust gas recirculation (EGR) device for recirculating a portion of intake gas back into an intake line. The exhaust gas recirculation (EGR) device may include a high-pressure EGR unit for recirculating intake gas in front of a catalyst and a low-pressure EGR unit for recirculating intake gas at the rear of the catalyst.

In addition, the engine system may include an intercooler configured to cool intake gas, which is formed by compressing the recirculated intake gas from the low-pressure EGR unit and fresh air using a turbocharger, and to supply the cooled intake gas to an intake manifold of an engine.

During the cooling of intake gas in the intercooler, saturated water vapor in the low-pressure EGR gas condenses, forming condensate. In an environment with low ambient temperature, such as in winter, or high humidity, such as during the rainy season, the condensate may freeze and block or merely block, a flow path of intake gas, causing a warning light to be turned on or the engine to malfunction while driving a vehicle.

The statements in this section merely provide background information related to the present disclosure and may not constitute prior art.

### SUMMARY

The present disclosure provides an intercooler and an engine system including the same, in which a flow path of intake gas is prevented from being blocked due to freezing in the intercooler and in which freezing may be effectively prevented without requiring a separate device to melt the ice.

According to an aspect of the present disclosure, an intercooler includes: a plurality of tubes configured to allow introduced intake gas to flow therein and flow out and arranged in a height direction of the intercooler; and a cooling fin structure forming a first cooling passage within at least one tube of the plurality of tubes. In particular, the cooling fin structure is disposed to be offset toward a first widthwise side within the at least one tube, thereby defining a cooling efficiency reduction passage on a second widthwise side within the at least one tube.

According to another aspect of the present disclosure, an intercooler includes: a plurality of tubes configured to allow intake gas to flow into and out of the plurality of tubes and arranged in a height direction of the intercooler; and a cooling fin structure forming a first cooling passage within each tube of the plurality of tubes. In particular, the cooling fin structure is configured so that, as a temperature of the intake gas within each tube of the plurality of tubes decreases, a flow of the intake gas becomes more biased toward a second widthwise side within each tube.

The cooling fin structure may be joined to one surface and the other surface of each of the plurality of tubes to divide the first cooling passage into a plurality of second cooling passages, and the cooling fin structure may be disposed to be offset to the first side within each tube so that a cross-sectional area of the cooling efficiency reduction passage on the second widthwise is larger than a cross-sectional area of each of the plurality of second cooling passages.

In an embodiment, a cross-section of the cooling efficiency reduction passage may have a shape in which a width is greater than a height thereof, and a cross-section of each of the plurality of second cooling passages may have a shape in which a width is smaller than its height.

In another embodiment, a cross-section of each of the plurality of tubes may have a shape in which a width is greater than its height, and the cooling fin structure may be disposed to be offset to the first side within the plurality of tubes so that a cross-sectional area of the cooling efficiency reduction passage on the second side is smaller than a total cross-sectional area of the plurality of second cooling passages.

A longitudinal length of each of the plurality of tubes may be greater than the width and height of the cross section of each of the plurality of tubes.

The cooling fin structure may be bent in multiple stages to have a continuously uneven cross-section.

The second widthwise side of the plurality of tubes may face an engine, and the first widthwise side of the plurality of tubes may face the outside of a vehicle.

The cooling fin structure may be configured so that, as a temperature of intake gas within the plurality of tubes decreases, the flow of the intake gas becomes more biased toward the second widthwise side within the plurality of tubes.

The cooling fin structure may be configured so that gas cooling efficiency on the second widthwise side within the plurality of tubes is lower than gas cooling efficiency on each of a center and the first widthwise side within the plurality of tubes.

According to another aspect of the present disclosure, an engine system includes: an engine mixing fuel with intake gas of the engine system and combusting the mixture; and an intercooler disposed to cool the intake gas of the engine system.

The engine system may further include: an intake line supplying the intake gas of the engine system to the engine; an exhaust line through which exhaust gas discharged from the engine flows; an exhaust gas recirculation (EGR) device including an EGR line branched from the exhaust line and connected to the intake line and an EGR cooler installed in the EGR line; and a turbocharger compressing the intake gas formed by merging a portion of the exhaust gas flowing through the EGR line with fresh air join, while being rotated by the exhaust gas. The intercooler is disposed in the intake line and cools the intake gas compressed by the turbocharger.

In another embodiment, an intercooler comprises: a plurality of tubes arranged in a height direction of the intercooler and configured to allow intake gas to flow into and out of the plurality of tubes and; and a cooling fin structures disposed within each tube of the plurality of tubes. The cooling fin structure has a wave-shaped configuration extending in a widthwise direction of each tube and configured to form a plurality of cooling passages within each tube. In particular, the cooling fin structure is offset toward a first widthwise side within each tube, thereby defining a cooling efficiency reduction passage on a second widthwise side within each tube, such that gas cooling efficiency on the second widthwise side within each tube is lower than gas cooling efficiency at a center portion and the first widthwise side of each tube.

Further areas of applicability should become apparent from the description provided herein. It should be understood that the description and specific embodiments are intended for purposes of illustration only and are not intended to limit the scope of the present disclosure.

### BRIEF DESCRIPTION OF DRAWINGS

The above and other aspects, features, and advantages of the present disclosure should be more clearly understood from the following detailed description, taken in conjunction with the accompanying drawings, in which:

FIG. 1 is a block diagram illustrating an engine system to which an intercooler according to an embodiment of the present disclosure is applied;

FIG. 2 is a perspective view illustrating an intercooler according to an embodiment of the present disclosure;

FIG. 3 is a perspective view illustrating a core of an intercooler according to an embodiment of the present disclosure; and

FIG. 4 is a cross-sectional view illustrating a cross-section (a Y-Z plane) of a core of an intercooler according to an embodiment of the present disclosure.

The drawings described herein are for illustration purposes only and are not intended to limit the scope of the present disclosure in any way.

### DETAILED DESCRIPTION

While the present disclosure may be modified in various ways and take on various alternative forms, specific embodiments thereof are shown in the drawings and described in detail below. However, it should be understood that there is no intent to limit the present disclosure to the particular forms disclosed, but on the contrary, the present disclosure covers all modifications, equivalents, and alternatives falling within the spirit and scope of the present disclosure.

Although the terms “first,” “second,” etc. may be used herein to describe various elements, these elements should not be limited by these terms. These terms are only used to distinguish one element from another. For example, a first element could be termed a second element, and a second element could similarly be termed a first element without departing from the scope of the present disclosure. As used herein, the term “and/or” includes any and all combinations of one or more of the associated listed items.

The terms used herein to describe embodiments of the present disclosure is not intended to limit the scope of the present disclosure. The articles “a,” and “an” are singular in that they have a single referent, however the use of the singular form in the present document should not preclude the presence of more than one referent. In other words, elements of the present disclosure referred to in the singular may number one or more, unless the context clearly indicates otherwise. It will be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

Unless defined in a different way, all the terms used herein including technical and scientific terms have the same meanings as understood by those having ordinary skill in the art to which the present disclosure pertains. Such terms as defined in generally used dictionaries should be construed to have the same meanings as those of the contexts of the related art, and unless clearly defined in the application, they should not be construed to have ideally or excessively formal meanings.

In the present disclosure, vehicles refer to a variety of vehicles that move transported objects, such as people, animals, or goods, from a starting point to a destination. These vehicles are not limited to vehicles that run on roads or tracks. When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function.

Hereinafter, embodiments of the present disclosure are described with reference to the accompanying drawings.

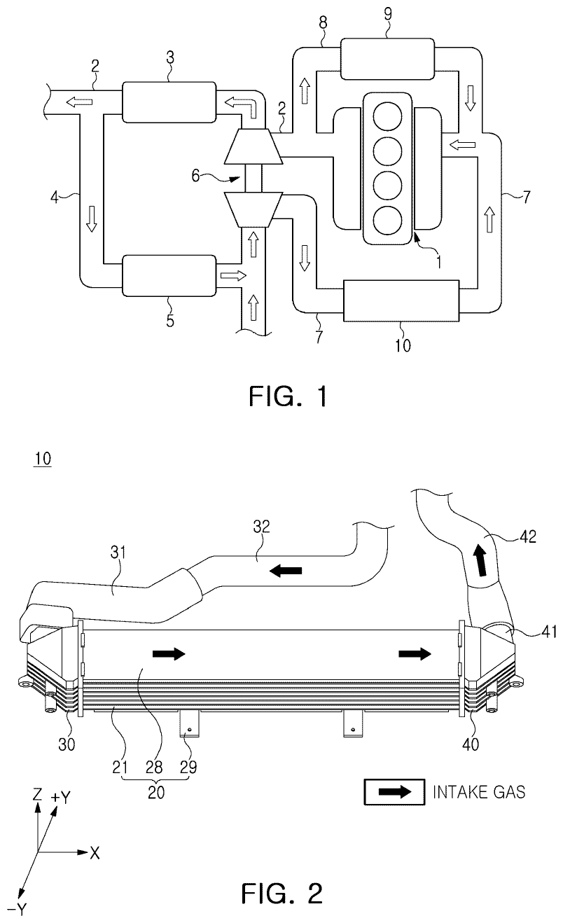

FIG. 1 is a block diagram illustrating an engine system to which an intercooler according to an embodiment of the present disclosure is applied. According to an embodiment of the present disclosure, an intercooler 10 may be applied to, for example, an engine system of a diesel vehicle, but is not necessarily limited thereto. Depending on the design, the intercooler 10 may be applied to an engine system of a gasoline vehicle, and the EGR device may be further simplified or smaller.

According to an embodiment of the present disclosure, referring to FIG. 1, an engine system may include at least one of an intercooler 10, an engine 1, an exhaust line 2, a diesel particulate filter (DPF) 3, an EGR line 4, an EGR cooler 5, a turbocharger 6, an intake line 7, a high-pressure EGR line 8, and a high-pressure EGR cooler 9. The EGR line 4 and the EGR cooler 5 may constitute an EGR device, and the high-pressure EGR line 8 and the high-pressure EGR cooler 9 may constitute a high-pressure EGR device.

Such an engine system may recirculate a portion of an exhaust gas discharged through the exhaust line 2 from an exhaust manifold of the engine 1 to the intake line 7. In an embodiment, the intercooler 10 may be disposed in the EGR device that recirculates the exhaust gas from the rear end (e.g., the downstream side) of the DPF 3 to the intake line 7.

In the EGR device, a portion (low-pressure EGR gas) of the exhaust gas that has passed through the DPF 3 and fresh air may join to form ‘intake gas’, which may be compressed through the turbocharger 6 and supplied to the intake manifold of the engine 1.

The intake gas is compressed by the turbocharger 6, increasing its temperature and causing expansion, which results in a decrease in an oxygen density. To improve this, the intercooler 10 may be installed in the intake line 7 at the rear end (e.g., the downstream) of the turbocharger to cool intake gas to a predetermined temperature.

According to an embodiment of the present disclosure, the intercooler 10 may cool (heat exchange) intake gas supplied from the turbocharger 6 through the intake line 7 and then supply cooled intake gas to the intake manifold of the engine 1.

In this manner, by using the intercooler 10, the high temperature intake gas compressed by the turbocharger 6 may be cooled to increase the oxygen density, and the intake efficiency of intake gas flowing into a combustion chamber of the engine 1 through the intake manifold may be increased, thereby improving the combustion efficiency of the engine.

FIG. 2 is a perspective view illustrating the intercooler according to an embodiment of the present disclosure. Referring to FIG. 2, the intercooler 10 may include a core 20, an intake inlet tank 30, intake inlet lines 31 and 32, an intake outlet tank 40, and intake outlet lines 41 and 42.

The intake inlet lines 31 and 32 and the intake outlet lines 41 and 42 may be connected to the intake line 7 of FIG. 1 or may be at least a portion of the intake line 7 of FIG. 1. Alternatively, one intake inlet line 32 and one the intake outlet line 42 may form at least a portion of the intake line 7 of FIG. 1 and may be connected to the other intake inlet line 31 and the other intake outlet line 41. The intake inlet lines 31 and 32 may be connected to the intake inlet tank 30 and may provide a path for intake gas to flow. The intake outlet lines 41 and 42 may be connected to the intake outlet tank 40 and may provide a path for intake gas to flow.

The intake inlet tank 30 may have an internal space corresponding to an intake gas entrance of the core 20, and the intake outlet tank 40 may have an internal space corresponding to an intake gas exit of the core 20. For example, the intake inlet tank 30 may have a structure in which a cross-sectional area—defined by an area of a cross-section in a Y-direction and a Z-direction-gradually increases from one end of the intake inlet lines 31 and 32 toward a first end of the core 20. The intake outlet tank 40 may have a structure in which a cross-sectional area gradually decreases from a second end of the core 20 toward one end of the intake outlet lines 41 and 42. Each of the intake inlet tank 30 and the intake outlet tank 40 may have a tapered shape.

The core 20 of the intercooler 10 may have a tube stack structure in which a plurality of tubes 21 are arranged in a height direction (e.g., in the Z-direction) of the intercooler 10. A housing 28 may cover upper and lower surfaces of the core 20 to protect the core 20 (e.g., protect against external impacts). The housing 28 may have a bracket 29 and may be coupled to a specific location of the vehicle through the bracket 29.

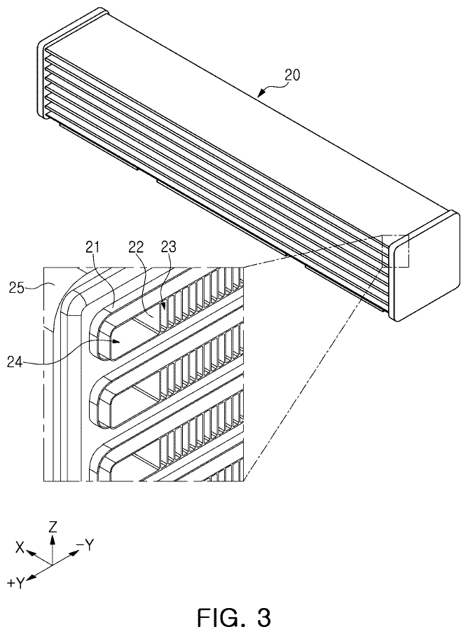

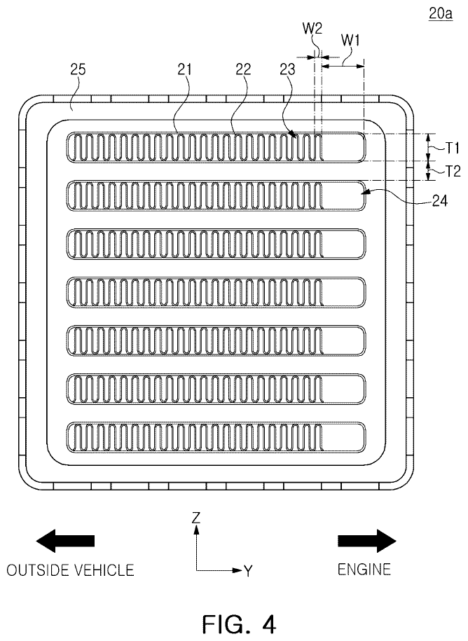

FIG. 3 is a perspective view illustrating a core of an intercooler according to an embodiment of the present disclosure, and FIG. 4 is a cross-sectional view illustrating a cross-section (a Y-Z plane) of a core of an intercooler according to an embodiment of the present disclosure.

Referring to FIGS. 3 and 4, the cores 20 and 20a of the intercooler, according to an embodiment of the present disclosure, may include the plurality of tubes 21 and a cooling fin structure 22. For example, a cup plate 25 may be coupled (e.g., bolted, screwed, stud-coupled, etc.) to both ends of the plurality of tubes 21 in a longitudinal direction (e.g., the X-direction) and may be coupled to the intake inlet tank (30 of FIG. 2) and the intake outlet tank (40 of FIG. 2).

The plurality of tubes 21 are configured to allow intake gas to flow in and out and may be arranged in the height direction (e.g., the Z-direction). For example, the cross-section (e.g., the cross-section defined in the Y-direction and the Z-direction) of each of the plurality of tubes 21 may be in a form (e.g., a forward horizontal type or an air dam type) in which the width (e.g., the dimension in the Y-direction) is longer than the height (e.g., the dimension in the Z-direction).

The cooling fin structure 22 may form a cooling passage 23 within the plurality of tubes 21. Intake gas flowing through the plurality of tubes 21 may be cooled by impinging on the inner surface of the plurality of tubes 21, such as through jet impingement. The cooling fin structure 22 may provide an additional surface (or an additional flow path of intake gas) on which intake gas flowing through the plurality of tubes 21 impinges, thereby allowing intake gas to be cooled more efficiently. For example, the cooling fin structure 22 and/or the plurality of tubes 21 may be formed of a material with high thermal conductivity (e.g., aluminum) and may absorb heat of intake gas and dissipate heat to the outside of the core 20. The dissipated heat may be cooled by the wind (i.e., ambient airflow) outside the vehicle as the vehicle moves.

The cooling fin structure 22 may be arranged to be offset to the other widthwise side (e.g., a −Y-direction) within the plurality of tubes 21 so as to form a cooling efficiency reduction passage 24 on one widthwise side (e.g., a +Y-direction) within the plurality of tubes 21. In other words, the cooling fin structure 22 is arranged closer to one widthwise side (e.g., the −Y direction) within at least one tube of the plurality of tubes 21. This offset positioning creates an open space on the opposite widthwise side (e.g., the +Y direction) within the at least one tube. The offset arrangement may indicate that the center of gravity of the cooling efficiency reduction passage 24 is offset from the center of gravity of the plurality of tubes 21. Accordingly, since the cooling fin structure 22 may not be disposed on one widthwise side (e.g., the +Y-direction) within the plurality of tubes 21, the cooling efficiency reduction passage 24 may not be affected by the cooling efficiency improvement effect of the cooling fin structure 22.

Therefore, the cooling efficiency of the cooling efficiency reduction passage 24 may be lower than the cooling efficiency of the cooling passage 23. In other words, the cooling fin structure 22 may be configured so that the gas cooling efficiency of one widthwise side (e.g., the +Y-direction) within the plurality of tubes 21 is lower than the gas cooling efficiency of each of the center and other widthwise side (e.g., the −Y-direction) within the plurality of tubes 21.

In an environment with low ambient temperature, such as in winter, or high humidity environment, such as during rainy season, moisture (e.g., condensate) in intake gas flowing through the plurality of tubes 21 may condense and freeze inside the plurality of tubes 21, thereby blocking the flow of intake gas.

Since the cooling efficiency of the cooling passage 23 is higher than that of the cooling efficiency reduction passage 24, condensation and freezing of moisture (e.g., condensate) in intake gas may preferentially block the cooling passage 23 compared to the cooling efficiency reduction passage 24.

In a state in which at least a portion of the cooling passage 23 is blocked, intake gas may flow more intensively in the cooling efficiency reduction passage 24 than in the cooling passage 23. Since the cooling efficiency of the cooling efficiency reduction passage 24 is lower than that of the cooling passage 23, the overall temperature of intake gas may be higher as it is more concentrated in the cooling efficiency reduction passage 24.

As the intake gas becomes more concentrated in the cooling efficiency reduction passage 24 and the overall temperature of the intake gas increases, ice in the cooling passage 23 may gradually melt. As the ice in the cooling passage 23 melts, intake gas may flow more concentratedly in the cooling passage 23.

To summarize the above process, the cooling fin structure 22 may be configured such that, as the temperature of intake gas decreases within the plurality of tubes 21, the flow of intake gas becomes more biased toward one widthwise side (e.g., the +Y-direction) within the plurality of tubes 21.

As a result, the intercooler according to an embodiment of the present disclosure may automatically melt the ice in the cooling passage 23 without the need for a separate device for melting the ice in the cooling passage 23. For example, the intercooler may not have a separate device for controlling whether to use the cooling efficiency reduction passage 24, and the cooling efficiency reduction passage 24 may be laid opened at least when the cooling passage 23 is in use.

One widthwise side (e.g., the +Y-direction) of the plurality of tubes 21 may face the engine (1 of FIG. 1), and the other widthwise side (e.g., the −Y-direction) of the plurality of tubes 21 may face the outside of the vehicle. Since the engine (1 of FIG. 1) may generate heat during a combustion process, the temperature around the engine (1 of FIG. 1) may be higher than the temperature (freezing temperature) of the outside of the vehicle, and therefore, intake gas flowing through the cooling efficiency reduction passage 24 located relatively closer to the engine (1 of FIG. 1) may not substantially cause freezing, and a phenomenon in which ice blocks the cooling efficiency reduction passage 24 may be prevented. For example, a position/posture of the bracket 29, as illustrated in FIG. 2, in the core 20 may be determined depending on whether the cooling efficiency reduction passage 24 is located relatively closer to the engine (1 in FIG. 1).

The cooling fin structure 22 may be joined to one surface (e.g., upper surface) and the other surface (e.g., lower surface) of each of the plurality of tubes 21 to divide the cooling passage 23 (i.e., first cooling passage) into a plurality of cooling passages 23 (i.e., second cooling passages). For example, the cooling fin structure 22 may be bent in multiple stages to have a continuously uneven cross-section. An outer surface of each concave portion of the uneven cross-section may support one surface (e.g., upper surface) of each of the plurality of tubes 21 and may be joined by welding (e.g., laser welding). An outer surface of each convex portion of the uneven cross-section may support the other surface (e.g., lower surface) of each of the plurality of tubes 21 and may be joined by welding (e.g., laser welding). In an embodiment, referring to FIG. 3, the cooling fin structures 22 may be disposed within each tube of the plurality of tubes 21 and has a wave-shaped configuration extending in a widthwise direction (e.g., the Y-direction) of each tube, thereby defining a plurality of cooling passages 23 within each tube 21.

For example, the cooling fin structure 22 may be formed in a straight shape in the longitudinal direction (e.g., the X-direction). In an embodiment, the wave shape may be implemented as a shape in which the Y coordinate periodically varies along the X coordinate within the plurality of tubes 21, similar to a sine wave.

The cooling fin structure 22 may be disposed to be offset to the other side (e.g., the −Y-direction) within the plurality of tubes 21 so that the cross-sectional area (corresponding to the product of W1 and T1) of the cooling efficiency reduction passage 24 is greater than the cross-sectional area (corresponding to the product of W2 and T1) of each of the plurality of cooling passages 23. The cross-sectional area (corresponding to the product of W2 and T1) of each of the plurality of cooling passages 23 may be substantially the same. The cross-sectional area may refer to an average value of the cross-sectional area for each X coordinate within the plurality of tubes 21. As the cross-sectional area (corresponding to the product of W1 and T1) of the cooling efficiency reduction passage 24 increases, the anti-freezing performance within the plurality of tubes 21 may be further improved.

The cooling fin structure 22 may be disposed to be offset to the other side (e.g., the −Y-direction) within the plurality of tubes 21 so that the cross-sectional area (corresponding to the product of W1 and T1) of the cooling efficiency reduction passage 24 is smaller than a total cross-sectional area (corresponding to a value obtained by additionally multiplying the product of W2 and T1 by the number of the plurality of cooling passages) of the plurality of cooling passages 23. Since the cross-sectional area (corresponding to the product of W1 and T1) of the cooling efficiency reduction passage 24 is not too large, the overall cooling efficiency of the plurality of tubes 21 may be secured.

For example, the cross-sectional area (corresponding to the product of W1 and T1) of the cooling efficiency reduction passage 24 may be approximately 10% (with a 5% margin of error) of the total cross-sectional area of the plurality of tubes 21. The approximately 10% (with a 5% margin of error) may be a ratio set to allow the minimum amount of intake gas intake to flow so that a boost pressure drop (based on a warning light turning on while the vehicle is driving) does not occur.

For example, the number of the plurality of cooling passages 23 may be 22 to 24, and the cross-sectional area (corresponding to the product of W1 and T1) of the cooling efficiency reduction passage 24 may be 2 to 5 times the cross-sectional area (corresponding to the product of W2 and T1) of each of the plurality of cooling passages 23, but is not limited thereto. For example, the cross-section of the cooling efficiency reduction passage 24 may be a form in which the width W1 is longer than the height T1, and the cross-section of each of the plurality of cooling passages 23 may be a form in which the width W2 is shorter than the height T1.

The intercooler and the engine system including the intercooler according to an embodiment of the present disclosure may effectively prevent a flow path of intake gas from being blocked due to freezing in the intercooler (e.g., there is no need to provide a separate device to melt the ice).

While example embodiments have been shown and described above, it should be apparent to those having ordinary skill in the art that modifications and variations could be made without departing from the scope of the present disclosure as defined by the appended claims.

What is claimed is:

1. An intercooler comprising:
a plurality of tubes arranged in a height direction of the intercooler and configured to allow intake gas to flow into and out of the plurality of tubes and; and
a cooling fin structure forming a first cooling passage within at least one tube of the plurality of tubes,
wherein the cooling fin structure is offset toward a first widthwise side within the at least one tube, thereby defining a cooling efficiency reduction passage on a second widthwise side within the at least one tube.

2. The intercooler of claim 1, wherein the cooling fin structure is joined to a first surface and a second surface of the at least one tube and is configured to divide the first cooling passage into a plurality of second cooling passages, and
a cross-sectional area of the cooling efficiency reduction passage is larger than a cross-sectional area of each second cooling passage of the plurality of second cooling passages.

3. The intercooler of claim 2, wherein a cross-section of the cooling efficiency reduction passage has a width greater than a height thereof, and
a cross-section of each second cooling passage of the plurality of second cooling passages has a width smaller than a height thereof.

4. The intercooler of claim 2, wherein a cross-section of each tube of the plurality of tubes has a width greater than a height thereof.

5. The intercooler of claim 2, wherein the cooling fin structure is bent in multiple stages to have a continuously uneven cross-section.

6. The intercooler of claim 1, wherein the cooling fin structure is disposed within each tube of the plurality of tubes and is offset toward the first widthwise side within each tube of the plurality of tubes, thereby defining the cooling efficiency reduction passage on the second widthwise side within each tube,
wherein the cooling fin structure is joined to a first surface and a second surface of the tube and is configured to divide the first cooling passage into a plurality of second cooling passages, and
wherein a cross-sectional area of the cooling efficiency reduction passage is smaller than a total cross-sectional area of the plurality of second cooling passages.

7. The intercooler of claim 6, wherein gas cooling efficiency on the second widthwise side within each tube of the plurality of tubes is lower than gas cooling efficiency at a center and the first widthwise side within each tube.

8. The intercooler of claim 6, wherein a longitudinal length of each tube of the plurality of tubes is greater than a width and a height of a cross section of each tube of the plurality of tubes.

9. The intercooler of claim 1, wherein the second widthwise side of the at least one tube faces an engine, and
the first widthwise side of the at least one tube faces an outside of a vehicle.

10. The intercooler of claim 1, wherein as a temperature of intake gas within the at least one tube decreases, a flow of the intake gas becomes more biased toward the second widthwise side within the at least one tube.

11. The intercooler of claim 1, wherein gas cooling efficiency on the second widthwise side within the at least one tube is lower than gas cooling efficiency on each of a center and the first widthwise side within the at least one tube.

12. An intercooler comprising:
a plurality of tubes arranged in a height direction of the intercooler and configured to allow intake gas to flow into and out of the plurality of tubes; and
a cooling fin structure forming a first cooling passage within each tube of the plurality of tubes,
wherein the cooling fin structure is configured so that, as a temperature of the intake gas within each tube of the plurality of tubes decreases, a flow of the intake gas becomes more biased toward a second widthwise side within each tube.

13. The intercooler of claim 12, wherein the cooling fin structure is configured so that gas cooling efficiency on the second widthwise side within each tube of the plurality of tubes is lower than gas cooling efficiency on each of a center and a first widthwise side within each tube of the plurality of tubes.

14. The intercooler of claim 13, wherein the second widthwise side of the plurality of tubes faces an engine, and the first widthwise side of the plurality of tubes faces an outside of a vehicle.

15. The intercooler of claim 12, wherein each tube of the plurality of tubes includes a surface and an opposite surface facing each other, the cooling fin structure is joined to the surface and the opposite surface of each tube, and
the cooling fin structure is bent in multiple stages to have a continuously uneven cross-section, the cooling fin structure configured to divide the first cooling passage into a plurality of second cooling passages.

16. An engine system comprising:
an engine configured to mix fuel with the intake gas and combust the mixture; and
the intercooler of claim 10 and disposed to cool the intake gas.

17. The engine system of claim 16, further comprising:
an intake line supplying the intake gas to the engine;
an exhaust line through which exhaust gas discharged from the engine flows;
an exhaust gas recirculation (EGR) device including:
an EGR line branched from the exhaust line and connected to the intake line, and
an EGR cooler installed in the EGR line; and
a turbocharger configured to compress the intake gas formed by merging a portion of the exhaust gas flowing through the EGR line with fresh air, the turbocharger being rotated by the exhaust gas,
wherein the intercooler is disposed in the intake line and configured to cool the intake gas compressed by the turbocharger.

18. An intercooler comprising:
a plurality of tubes arranged in a height direction of the intercooler and configured to allow intake gas to flow into and out of the plurality of tubes and; and
a cooling fin structures disposed within each tube of the plurality of tubes,
wherein the cooling fin structure has a wave-shaped configuration extending in a widthwise direction of each tube and configured to form a plurality of cooling passages within each tube,
wherein the cooling fin structure is offset toward a first widthwise side within each tube, thereby defining a cooling efficiency reduction passage on a second widthwise side within each tube, such that gas cooling efficiency on the second widthwise side within each tube is lower than gas cooling efficiency at a center portion and the first widthwise side of each tube.

19. The intercooler of claim 18, wherein a cross-sectional area of the cooling efficiency reduction passage is greater than a cross-sectional area of each cooling passage of the plurality of cooling passages in each tube.

20. The intercooler of claim 19, wherein the second widthwise side of the plurality of tubes faces an engine, and the first widthwise side of the plurality of tubes faces an outside of a vehicle.
